(19) United States
(12) Patent Application Publication
(10) Pub. No.: US 2024/0413526 A1
(43) Pub. Date: Dec. 12, 2024

(54) ANTENNA FEEDING STRUCTURE AND ELECTRONIC DEVICE

(71) Applicant: GOERTEK INC., Weifang (CN)

(72) Inventors: Katsumi SAITO, Weifang (CN); Kenichiro Kodama, Weifang (CN)

(21) Appl. No.: 18/811,908

(22) Filed: Aug. 22, 2024

Related U.S. Application Data
(63) Continuation of application No. PCT/CN2022/098089, filed on Jun. 10, 2022.

(51) Int. Cl. H01Q 1/50

(52) U.S. Cl. CPC H01Q 1/50

(57) ABSTRACT

Disclosed are an antenna feeding structure and an electronic device. The antenna feeding structure includes: a first conductor, electrically coupled to a part of an antenna, where the part of the antenna is located at a housing of an electronic device; a second conductor, electrically coupled to radio-frequency circuitry on a circuit board, where the second conductor is located on a part of the circuit board, and the part of the circuit board is enclosed in the housing; and an isolating layer, located between the first conductor and the second conductor, where the first conductor is isolated from the second conductor via the isolating layer. The antenna feeding structure is more robust to external impact and more tolerant for misalignment between the antenna and the circuit board, and induces no compressive force against the antenna and the circuit board.

### CROSS-REFERENCE TO RELATED APPLICATIONS

This application is a continuation application of International Application No. PCT/CN2022/098089, filed on Jun. 10, 2022. The disclosure of the above-mentioned application is incorporated herein by reference in its entirety.

### TECHNICAL FIELD

The present application relates to the technical field of wireless communications, and in particular to an antenna feeding structure and an electronic device including the same.

### BACKGROUND

Recent decades have witnessed fast development and prosperity of various electronic devices in people's daily life. An increasing requirement on convenient “anytime and anywhere” accesses to the Internet and Wireless Local Area Network (WLAN) s leads to a rapid development of electronic devices that are wireless and portable, such as mobile phones, tablets and handheld game consoles. Miniaturization of wireless devices is a trend in both research and business, which aims at merging the wireless communication into each application scenario in people's daily life. A prospect is that the wireless devices are light, so as to provide high-quality wireless accesses without putting a significant burden on users. Such objective demands wireless devices that are increasingly compact, and thereby raises great challenges on downscaling and reusage of components, such as integrated circuits, detectors, batteries, and antennas.

### SUMMARY

An antenna feeding structure and an electronic device comprising the same are provided according to embodiments of the present application, in order to address at least an issue that conventional elastic feeding structures would enhance compressive stress within a housing and therefore reduce reliability of an electronic device.

In a first aspect, an antenna feeding structure is provided, including: a first conductor, electrically coupled to a part of an antenna, where the part of the antenna is located at a housing of an electronic device; a second conductor, electrically coupled to radio-frequency (RF) circuitry on a circuit board, where the second conductor is located on a part of the circuit board, and the part of the circuit board is enclosed in the housing; and an isolating layer, located between the first conductor and the second conductor, where the first conductor is isolated from the second conductor via the isolating layer.

In an embodiment, each of the first conductor and the second conductor is a sheet. The first conductor is conformed to at least a part of the second conductor, or the second conductor is conformed to at least a part of the first conductor.

In an embodiment, the first conductor includes multiple first sub-conductors which are separated from each other.

In an embodiment, a first sub-conductor of the multiple first sub-conductors is electrically coupled to the part of the antenna, and another first sub-conductor of the multiple first sub-conductors is electrically coupled to a part of another antenna. The part of another antenna is located at the housing.

In an embodiment, the antenna feeding structure further includes first switching circuitry, which is configured to select one of the multiple the first sub-conductors to connect the part of the antenna.

In an embodiment, the second conductor includes multiple second sub-conductors which are separated from each other.

In an embodiment, a second sub-conductor of the multiple second sub-conductors is electrically coupled to the RF circuitry, and another second sub-conductor of the multiple second sub-conductors is electrically coupled to another RF circuitry on the circuit board.

In an embodiment, the antenna feeding structure further includes second switching circuitry, which is configured to select one of the multiple second sub-conductors to connect the RF circuitry.

In an embodiment, at least a part of the isolating layer is made of a dielectric material.

In an embodiment, the first conductor is exposed at an outer surface of the housing or embedded in the housing. The isolating layer is a part of the housing, and the part of the circuit board is separated from the housing by at least the second conductor.

In an embodiment, at least a part of the isolating layer is made of air or a gas.

In an embodiment, the antenna feeding structure serves as a capacitor in a matching circuit of the antenna.

In an embodiment, the isolating layer has a first thickness in a case that the antenna transmits or receives wireless signals of a first frequency, and has a second thickness in a case that the antenna transmits or receives wireless signals of a second frequency. The first thickness is not equal to the second thickness, and the first frequency is different from the second frequency.

In an embodiment, an overlapping region between the first conductor and the second conductor, along a thickness direction of the isolating layer, has a first area in a case that the antenna transmits or receives wireless signals of a first frequency, and has a second area in a case that the antenna transmits or receives wireless signals of a second frequency. The first area is not equal to the second area, and the first frequency is different from the second frequency.

In an embodiment, the antenna feeding structure serves as a direct-current filter between the antenna and the RF circuitry.

In an embodiment, the first conductor is fixedly connected to the housing.

In a second aspect, an electronic device is provided, including: a housing, an antenna located at the housing, a circuit board, and any foregoing antenna feeding structure.

In an embodiment, no component physically connecting the antenna and the circuit board is under compressive stress.

In an embodiment, the part of the antenna is a conducting pattern disposed at a surface of the housing.

In an embodiment, the electronic device further includes an insulating layer located between the first conductor and the part of antenna. The first conductor is electrically coupled to the part of the antenna via a conductor running through the insulating layer.

In view of the above, the antenna feeding structure according to embodiments of the present application is applicable to the electronic device. The antenna feeding structure includes the first conductor, the second conductor, and the isolating layer. The first conductor is electrically coupled to the part of the antenna, and the part of the antenna is located at the housing of the electronic device. The second conductor is electrically coupled to the RF circuitry on the circuit board and located on a part of the circuit board, and the part of the circuit board is enclosed in the housing. The isolating layer is located between the first conductor and the second conductor, and the first conductor is isolated from the second conductor via the isolating layer. The antenna feeding structure is more robust to external impact and more tolerant for misalignment between the antenna and the circuit board, and induces no compressive force against the antenna and the circuit board. Hence, a cost of assemblage of is reduced and reliability is improved for the electronic device.

### BRIEF DESCRIPTION OF THE DRAWINGS

For clearer illustration of the technical solutions according to embodiments of the present application or conventional techniques, hereinafter briefly described are the drawings to be applied in embodiments of the present application or conventional techniques. Apparently, the drawings in the following descriptions are only some embodiments of the present application, and other drawings may be obtained by those skilled in the art based on the provided drawings without creative efforts.

FIG. 1A and FIG. 1B are antenna feeding structures in conventional technology.

FIG. 2 is a schematic structural diagram of an electronic device including an antenna feeding structure according to an embodiment of the present application.

FIG. 3 is a schematic structural diagram of an antenna feeding structure according to an embodiment of the present application.

FIG. 4 is a schematic structural diagram of an antenna feeding structure according to another embodiment of the present application.

FIG. 5 is a schematic structural diagram of an antenna feeding structure according to another embodiment of the present application.

FIG. 6 is a schematic structural diagram of an antenna feeding structure according to another embodiment of the present application.

FIG. 7 is a schematic structural diagram of an antenna feeding structure according to another embodiment of the present application.

FIG. 8A and FIG. 8B are schematic diagrams of a circuit including an antenna, radio frequency circuitry, and an antenna feeding structure according to embodiments of the present application.

FIG. 9A and FIG. 9B are schematic structural diagrams of an antenna feeding structure according to other embodiments of the present application.

FIG. 10A and FIG. 10B are schematic structural diagrams of an antenna feeding structure according to other embodiments of the present application.

FIG. 11 is a schematic three-dimensional structural diagram of an antenna feeding structure according to an embodiment of the present application.

FIG. 12A is a graph of a reflection coefficient of an antenna with respect to a frequency of wireless signals corresponding to a pogo-pin and antenna feeding structures according to embodiments of the present application.

FIG. 12B is a graph of antenna efficiency with respect to a frequency of wireless signals corresponding to a pogo-pin and antenna feeding structures according to embodiments of the present application.

### DETAILED DESCRIPTION OF THE EMBODIMENTS

In order to make the object, technical solutions and advantages of the present application clearer, hereinafter technical solutions in some embodiments of the present application are described in conjunction with the drawings in some embodiments of the present application. Apparently, the described embodiments are only some rather than all of the embodiments of the present application. Any other embodiments obtained based on the embodiments of the present application by those skilled in the art without any creative effort fall within the scope of protection of the present application.

Wireless communication concerns transmitting, receiving, or exchanging (i.e., both transmitting and receiving) wireless data and/or wireless signals. In transmission, a wireless device may modulate data and/or signals into oscillating currents, then convert the oscillating currents into electromagnetic waves that carry the data and/or the signals, and transmit the electromagnetic waves to, for example, another wireless device. In reception which is inverse, a wireless device may receive electromagnetic waves that carry data and/or signals from, for example, another wireless signal, convert the electromagnetic waves into oscillating currents, and then demodulate the oscillating currents to acquire the data and/or the signals that can be handled or processed. Generally, an antenna in the wireless device is configured to implement the transmission and the reception of the electromagnetic waves, and the conversion between the electromagnetic waves and the oscillating currents. Radio-frequency (RF) circuitry in the wireless device is configured to implement the modulation and the demodulation of the data and/or the signals. Hence, both the antenna and the RF circuitry are key elements in the wireless device, and oscillating currents are required to flow between the two elements to implement the wireless communication.

Most functional circuits of the wireless devices are integrated onto a printed circuit board (PCB), which is also called a main circuit board, to improve the compactness of the wireless device and reliability of data processing. The main circuit board is usually mounted on, for example, a chassis which is enclosed by a housing of the wireless device for protection. Generally, the RF circuitry as well as processing circuitry (e.g., one or more processors) for processing the data and/or the signals are located on the main circuit board. On the other hand, the antenna is usually attached to the housing rather than the main circuit board of the wireless device, so as to ensure good quality of the electromagnetic waves that are transmitted and/or received, as well as avoid interference between the electromagnetic waves and other elements on the main circuit board. In some application scenarios, the main circuit board is even subject to electromagnetic shielding, which is obviously not an ideal carrier of the antenna. Therefore, it is necessary to provide a structure connecting the antenna and the main circuit board, such that the antenna can be electrically coupled to the RF circuitry on the main circuit board. Such structure is called an antenna feeding structure, since it feeds modulated oscillating currents from the RF circuit into the antenna, or feed to-be-demodulated oscillating currents reversely. In order to guarantee good quality of wireless communications, the antenna feeding structure should ensure robust transfer of the oscillating currents between the antenna and the RF circuitry.

In conventional technology, elastic antenna feeding structure is utilized to implement the robust connection between the antenna and the RF circuitry. Specifically, the elastic antenna feeding structure may be disposed between the antenna, which is attached to the housing, and the main circuit board. In one aspect, the elastic antenna feeding structure provides an electrical connection between the antenna and the RF circuitry. For example, an end of the elastic antenna feeding structure abuts against the antenna, while another end abuts against to a contact on the main circuit board and electrically connected to the RF circuitry via wiring. In another aspect, the elastic antenna feeding structure is deformed (i.e., compressed) and thereby provides constant stress between the antenna and the RF circuitry. Generally, the elastic antenna feeding structure is compressed during the assemblage of the wireless device, for example, by pressing the antenna toward the main circuit board, and hence it deforms under compressive force. The deformed elastic antenna feeding structure is capable to press tightly against both the antenna and the main circuit board, and hence the electrical connection is maintained and is robust against gentle movement of the wireless device, for example, slight vibration or shaking of the wireless device. The elastic antenna feeding structure may be implemented in various forms.

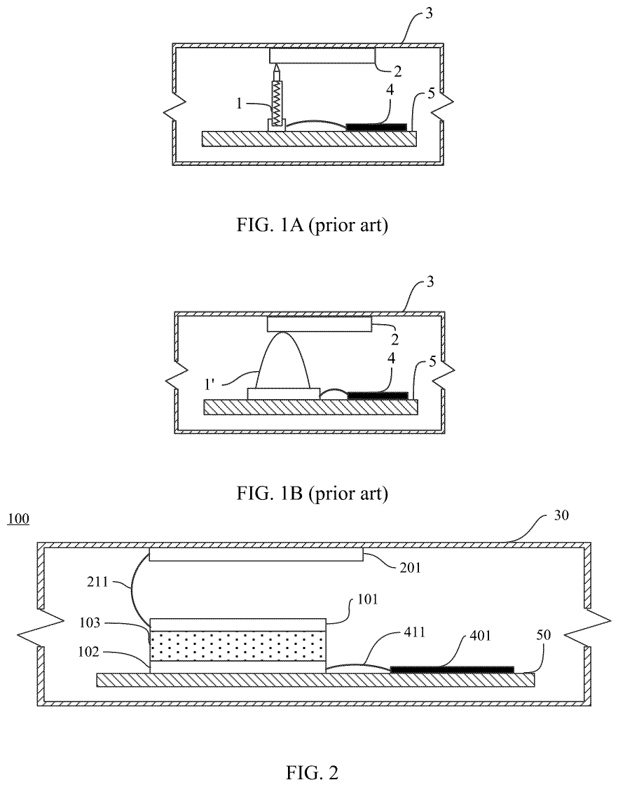

Reference is made to FIGS. 1A and 1b, in which two typical forms of the elastic antenna feeding structure of wireless devices are illustrated. In FIG. 1A, the elastic antenna feeding structure is a pogo-pin 1 which is compressed and presses against an antenna 2 attached to an inner surface of a housing 3 and against a PCB 5 on which an RF circuit 4 is located. The pogo-pin is electrically connected to the RF circuit 4. FIG. 1B is substantially identical to FIG. 1A, except that the elastic antenna feeding structure is a leaf spring l′ which is compressed and presses against both the antenna 2 and the PCB 4.

As shown in the above cases, the deformed elastic antenna feeding structure is under stress, and hence a constant force is applied on the antenna (thereby on the housing) and the main circuit board (e.g., the PCB) inside the wireless device. Hence, a material and a structure of both the antenna and the housing need to be carefully selected such that they would not easily break or yield under the force, which brings restrictions to the wireless device. Moreover, since the wireless device is assembled under pressure, a slight positional mismatch between the elastic antenna feeding structure and the antenna, or between the elastic antenna feeding structure and the main circuit board, would bring disastrous malfunction. Hereinafter FIG. 1A is taken as an example. When the pogo-pin 1 is subject to even a slight slide or a slight tilt with respect to antenna 2, the compressive stress may be released at least partially as long as the pogo-pin 1 has enough space to rebound, and the rebound may further enhance the slide and the tilt and eventually disconnect the antenna 2 and the RF circuit 4. Therefore, the elastic antenna feeding structure, although may be robust against gentle movement, cannot handle violent movement (e.g., drop, collide, abrupt acceleration, or abrupt deceleration) or even slight deformation of the wireless device. An anti-slide or anti-tilt mechanism may be feasible, but as discussed in the background section, electronic devices particularly wireless electronic devices are becoming more and more compact, which renders such mechanism space-extravagant.

In view of the above issues, an antenna feeding structure is provided according to embodiments of the present application. The antenna feeding structure is capable to provide stable electrical connection between an antenna and RF circuitry on a main circuit board (e.g., PCB), ensure robustness against drastic movement and deformation, and facilitate simple architecture of the wireless device.

Reference is made to FIG. 2, which is a schematic structural diagram of a wireless device including an antenna feeding structure according to an embodiment of the present application. As shown in FIG. 2, the wireless device 100 includes the antenna feeding structure, a housing 30, an antenna, and a circuit board 50, and the antenna feeding structure includes a first conductor 101, a second conductor 102, and an isolating layer 103.

Unless defined otherwise, herein the term “wireless device” refers to an electronic device capable of performing wireless communications. It is appreciated that a wireless device may further be capable of performing communications via wired connections. For example, a laptop computer may have a wireless network card for wireless communications through Wireless Fidelity (Wi-Fi) and Bluetooth™, and hence qualifies as the wireless device, while it may further be provided with a registered jack for wired communications via a network cable. Accordingly, it is appreciated that the wireless device 100 may include, but is not limited to, other devices such as a mobile phone, an earbud, smart eyeglasses, a smart wristband, a tablet computer, a head-mounted display, a game controller, a smart television, or the like. The present application is not limited to any specific case that is aforementioned.

The housing 30 of the wireless device 100 may be made of various materials according to specific application scenarios. As an example, the housing 30 may be made of a conducting material such as metal or alloy, and the conducting material may be coated by an oxide or nitride layer for protection. As another example, the housing 30 may be made of a dielectric material such as resin, plastic, rubber, or one or more layers of semiconductor. It is appreciated that the housing 30 may further be implemented as a combination of different materials, for example, one material may be embedded in, laminated with, or inlaid in another material. The housing 30 may adopt various structures and/or various shapes, and may be elastic, flexible, or rigid. The present application is not limited to any specific case that is aforementioned.

The circuit board 50 of the wireless device 100 may be the main circuit board, as described in the foregoing description, a PCB, or any circuit board that carries radio-frequency (RF) circuitry 401 in the wireless device. The circuit board 50, though depicted as a plate in FIG. 2, may be shaped otherwise on requirement, for example, to make the utmost of a space within the housing 30. In an embodiment, the circuit board 50 may be conformed with an inner surface of a part of the housing 30. In practice, the circuit board 50 may be mounted on a chassis fixed to a part of the housing 30, and the chassis may be may be elastic, flexible, or rigid. It is further appreciated that the circuit board 50 may carry functional circuitry other than the RF circuitry 401, and the functional circuitry may be a processor, a specific chip, or the like. The present application is not limited to any specific case that is aforementioned.

A type of the antenna of the wireless device 100 may be selected based on an actual application scenario. For example, the antenna may be a monopole antenna, a dipole antenna, a loop antenna, a folded antenna, or a cloverleaf antenna, and may be a half-wavelength antenna, a quarter-wavelength antenna, or even a half-quarter-wavelength antenna. A shape and a dimension of the antenna may be designed based on a shape of the housing 30 and/or a requirement of the wireless communication performed by the wireless device 100. The antenna may include, but is not limited to, a stripe antenna consisting of metal plates and/or metal stripes. In some embodiment, the antenna is a conducting pattern disposed or printed at a surface of the housing through, for example, laser direct structuring. The present application is not limited to any specific case that is aforementioned.

The first conductor 101 is electrically coupled to a part 201 of the antenna. That is, the part 201 refers to a part at which the antenna is coupled to the first conductor, and is not limited to any specific portion or any specific shape. The coupling is implemented by a component 211 as depicted in FIG. 2, which may be a metal stripe, a wire, or merely a conductor connected between the part 201 and the first conductor 101. In some embodiments, the first conductor 101 may serve as another part of the antenna. That is, the antenna includes the first conductor 101, the coupling component 211, and the part 201. It is appreciated that the antenna may additionally include another part electrically connected to any of the above three parts. In this embodiment, the part 201 of the antenna is located at the housing 30 of the wireless device 100. A specific positional relationship between the part 201 and the housing 30 is not limited herein. As an example, the part 201 may be attached to an inner surface of the housing 30, as depicted in FIG. 2. Alternatively, the part 201 may be attached to an outer surface of the housing 30, may be embedded in the housing 30, or may be partially embedded and partially exposed at the inner surface or the outer surface of the housing 30. It is appreciated that in such cases, the coupling component 211 may run through or extend into the housing 30 to achieve the electrical connection between the part 201 and the first conductor 101.

The second conductor 102 is electrically coupled to the RF circuitry 401 on the circuit board 50. The coupling is implemented by another coupling component 411, as depicted in FIG. 2, which may be a metal stripe, a wire, or merely a conductor connected between the RF circuitry 401 and the second conductor 102. In this embodiment, the second conductor 102 is located on a part of the circuit board 50, and such part of the circuit board 50 is enclosed in the housing 30. In practice, the RF circuitry 401 and the second conductor 102 may be attached to a same surface or opposite surfaces of the circuit board 50. The coupling component 411 may be independent from the circuit board 50, for example, as depicted in FIG. 2, or may be implement by at least one wiring layer (or interconnection layer) in the circuit board 50. As an example, the wiring layer may be the topmost wiring layer in the circuit board 50, and may be exposed at the surface of the circuit board 50. As another example, the wiring layer may run through the circuit board 50 in order to achieve electrical connection between the opposite surfaces. The wiring layer may be located within the part of the circuit board 50, i.e., the part at which the second conductor 102 is located, or may extend out of the part of the circuit board 50, which is not limited herein. Moreover, other part(s) of the circuit board 50 may be either enclosed in the housing or stick out of the housing 30, as long as the aforementioned part at which the second conductor is located is enclosed in the housing 30. That is, the circuit board 50 may be thoroughly or partially enclosed in the housing 30. In some embodiments, the aforementioned part of the circuit board 50 is separated from the housing 30, while other part of the circuit board may be either connected or fixed to the housing 30. The separation may be implemented by a material layer or simply by a gap.

The isolating layer 103 is located between the first conductor 101 and the second conductor 102. The isolating layer 103 may include only one layer, or may include multiple stacked layers. Generally, the isolating layer 103 includes a dielectric material, for example, a semiconductor, a polymer, oxide, nitride, ceramic, or rubber. Alternatively, the isolating layer may simply be air or a gas filled between the first conductor 101 and the second conductor 102. In case of using the air or the gas, the first conductor 101 may be fixed to the housing 30. In this embodiment, the first conductor 101 is isolated from the second conductor 102 via the isolating layer 103. That is, the first conductor 101 and the second conductor 102 does not contact each other. Hence, the antenna feeding structure, as a whole, may behave like a capacitor in which the first conductor 101 and the second conductor 102 serve as plates while the isolating layer 103 serves as dielectric, and the oscillating currents between the RF circuitry 401 and the antenna is capable to pass the antenna feeding structure.

In the foregoing antenna feeding structure, the part 201 of the antenna is coupled to the first conductor 101 while the RF circuitry 401 is coupled to the second conductor 102, and the first conductor 101 and the second conductor 102 are isolated from each other via the isolating layer 103. Therefore, the oscillating currents between the RF circuitry 401 and the antenna can be transferred via the capacitor-like antenna feeding structure. Such antenna feeding structure provides a large area rather than a single point (for example, when using a pin) for feeding between the RF circuitry 401 located on the circuit board 50 and the antenna attached to the housing 30. Although a slight displacement may be hazardous to the single feeding point, it is trivial for the large feeding area. Hence, the capacitor-like antenna feeding structure is more robust to large impact and more tolerant for positional aberration, and can provide a more stable connection against abrupt movement and large deformation. Consequently, there is no need to apply compressive stress on such antenna feeding structure to press it against the circuit board 50 and the antenna (as the pogo-pin or the leaf spring does when implement the feeding), which not only simplifies assemblage of the wireless device 100 but also prevents potential malfunction due to release of the compressive stress.

In the foregoing embodiments, the antenna feeding structure is provided. The antenna feeding structure is applicable to an electronic device, and includes the first conductor, the second conductor, and the isolating layer. The first conductor is electrically coupled to the part of the antenna, and the part of the antenna is located at the housing of the electronic device. The second conductor is electrically coupled to the RF circuitry on the circuit board and located on a part of the circuit board, and the part of the circuit board is enclosed in the housing. The isolating layer is located between the first conductor and the second conductor, and the first conductor is isolated from the second conductor via the isolating layer. The antenna feeding structure is more robust to external impact and more tolerant for misalignment between the antenna and the circuit board, and induces no compressive force against the antenna and the circuit board. Hence, a cost of assemblage of is reduced and reliability is improved for the electronic device.

Hereinafter some embodiments of the present application are illustrated.

In one embodiment, each of the first conductor 101 and the second conductor 102 is a conducting sheet. For example, each of the first conductor 101 and the second conductor 102 may be a conducting plate as illustrated in FIG. 2, or may be a thin film formed by any conducting material. Generally, a projection of the first conductor 101 on the circuit board is identical to a projection of the second conductor 102 on the circuit board 50 in both dimension and position, and the first conductor 101 and the second conductor 101 are conformed (i.e., have the same shapes or substantially same shapes) with each other, such that the isolating layer 103 between the two are uniform in thickness. Alternatively, the projection of the first conductor 101 may be either smaller or larger than the projection of the second conductor 102, and/or the projections of the first conductor 101 and the second conductor 102 may overlap only partially. In such cases, the first conductor 101 may be conformed with a part of the second conductor 102, or the second conductor 102 may be conformed with a part of the first conductor 101. Such architecture is flexible and is capable to provide one-to-multiple or multiple-to-one feeding between the RF circuitry 401 and the antenna(s), which would be illustrated in following description.

It is appreciated that the projections of both the first conductor 101 and the second conductor 102 may have various shapes, such as square, rectangular, circle, trapezoid, or even irregular shapes, which are not limited herein. Moreover, each of the first conductor 101 and the second conductor 102 may have a three-dimensional shape other than the sheet, such as a block, a wedge, a concave, a convex, which is not limited herein. In such cases, a surface of the first conductor 101 facing the second conductor 102 may be conformed to at least a part of a surface of the second conductor 102 facing the first conductor 101, or a surface of the second conductor 102 facing the first conductor 101 may be conformed to at least a part of a surface of the first conductor 101 facing the second conductor 102, in order to render the isolating layer 103 uniform between the first conductor 101 and the second conductor 102.

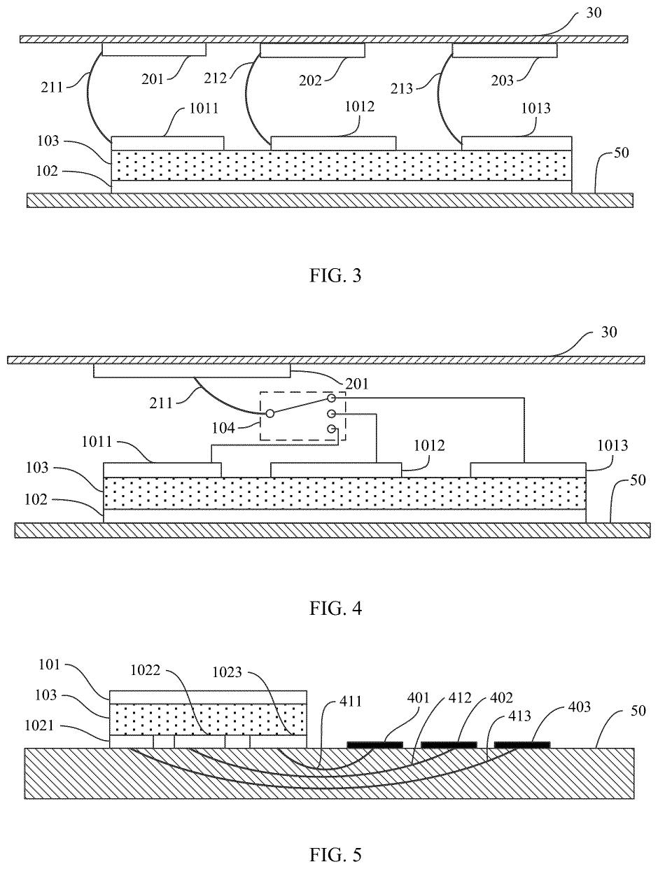

In one embodiment, the first conductor 101 includes multiple first sub-conductors which are separated from each other. Reference is made to FIGS. 3 and 4, which are schematic structural diagrams of antenna feeding structures according to embodiments of the present application. As shown in FIGS. 3 and 4, the first conductor 101 includes three first sub-conductors 1011, 1012, and 1013 which are separated. The first conductor 101 may be equally divided (that is, the first sub-conductors 1011 to 1013 are identical), partially equally divided (that is, only two of the first sub-conductors 1011 to 1013 are identical), or completely unequally divided (that is, the first sub-conductors 1011 to 1013 are different from each other). The division of the first conductor 101 is capable to create multiple sub-feeding structures (three sub-feeding structures in FIGS. 3 and 4) in the antenna feeding structure. The multiple sub-feeding structures may be configured to implement feeding between the RF circuitry 401 and multiple antennas, and/or may provide multiple feeding paths between the RF circuitry 401 and one antenna.

Reference is further made to FIG. 3. In one embodiment, the wireless device 100 includes three antennas (not depicted), that is, a first antenna, a second antenna, and a third antenna, which include the part 201, a part 202, and a part 203, respectively. Each of the three antennas may refer to the antenna of the foregoing embodiments, and the three antennas may be identical, partially identical, or different from each other in dimensions, shapes, or frequency bands. In this embodiment, the part 201 of the first antenna, the part 202 of the second antenna, and the part 203 of the third antenna are all located at the housing 30. Similar to an embodiment as shown in FIG. 2, the part 201 is electrically coupled to the first conductor 101, specifically the first sub-conductor 1011 via the coupling component 211. Moreover, the part 202 is electrically coupled to the first conductor 101, specifically the second sub-conductor 1012 via the coupling component 212, and the part 203 is electrically coupled to the first conductor 101, specifically the third sub-conductor 1013 via the coupling component 213. Thereby, there are three capacitor-like sub-feeding structure in the antenna feeding structure, and the RF circuitry 401 (not depicted in FIG. 3) is capable to transmit and receive oscillating currents to/from all the three antennas via the three sub-feeding structures, respectively. It can be seen that a function of the antenna feeding structure is expanded. During wireless communication of the wireless device 100, the RF circuitry 401 may operate with the three antennas simultaneously, especially when the three antennas are configured to transmit or receive different copies of the same data or signals. Alternatively, the RF circuitry 401 may operate with one or two of the three antennas each time, and the one or two antennas may be selected from the three antennas through switching circuitry. For example, the switching circuitry may include a switch or a switching transistor connected between each pair of the antenna part and the first sub-conductor. It is appreciated that different pairs of the antenna part and the first sub-conductors may be identically configured as redundancy to improve system robustness, or may be differently configured to provide different functions, for example, to transmit or receive electromagnetic waves of different frequency bands.

Reference is further made to FIG. 4. In one embodiment, the antenna feeding structure further includes first switching circuitry 104. The first switching circuitry 104 is configured to select one of the first sub-conductors 1011, 1012, or 1013 to connect the part 201 of the antenna. The first switching circuitry 104 may have a single-pole three-throw structure as shown in FIG. 4. The single pole corresponds to a contact electrically connected to the coupling component 211, and three throws correspond to three contacts electrically connected to the first sub-conductors 1011, 1012, and 1013, respectively. The part 201 can be coupled to the first conductor 101, specifically to one of the three first sub-conductors 1011, 1012, or 1013, via the coupling component 211 and the first switching circuitry 104. Similar to an embodiment as shown in FIG. 3, there are three capacitor-like sub-feeding structure in the antenna feeding structure, and the RF circuitry 401 (not depicted in FIG. 4) is capable to transmit and receive oscillating currents to/from the antenna via a selected one of the three sub-feeding structures. The sub-feeding structures may be identically or substantially identically configured as parallel feeding paths between the RF circuitry 401 and the antenna, in order to provide redundancy and thereby improve robustness of the antenna feeding structure. Alternatively, the sub-feeding structures may be configured differently such that the antenna when operate with different first sub-conductors is capable to perform different functions, for example, transmit or receive electromagnetic waves in different frequency bands. It is appreciated that the switching circuitry 104 may be implemented in other structures as long as the selection function can be achieved.

It is appreciated that the above cases of three first sub-conductors are merely examples illustrated in FIGS. 3 and 4. In practice, a quantity of the first sub-conductors may be, for example, two, four, five, or more. Those skilled in the art can deduce these cases by analogy on a basis of the embodiments as shown in FIGS. 3 and 4. Moreover, in some embodiments, technical solutions as shown in FIGS. 3 and 4 may be combined. That is, a first group of the multiple first sub-conductors may be configured to couple different antennas as illustrated in FIG. 3, and a second group of the multiple first sub-conductors may be configured to couple the same antenna via the first switching circuitry as shown in FIG. 4. In one embodiment, one or more first sub-conductors may belong to both the first group and the second group. In another embodiment, none of the first sub-conductors belongs to both the first group and the second group. The present application is not limited thereto.

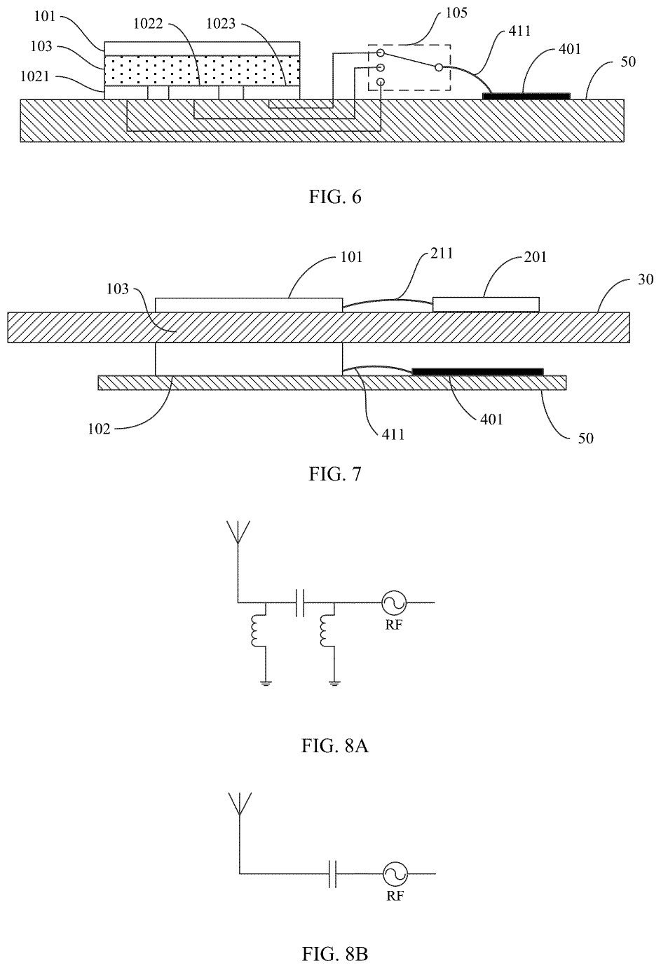

In one embodiment, the second conductor 102 includes multiple second sub-conductors which are separated from each other. Reference is made FIGS. 5 and 6, which are schematic structural diagrams of antenna feeding structures according to other embodiments of the present application. As shown in FIGS. 5 and 6, the second conductor 102 includes three second sub-conductors 2011, 2012, and 2013 which are separated. The second conductor 102 may be equally divided (that is, the second sub-conductors 2011 to 2012 are identical), partially equally divided, (that is, only two of the second sub-conductors 2011 to 2013 are identical) or completely unequally divided (that is, the second sub-conductors 2011 to 2013 are different from each other). Similar to the first conductor 101 in the foregoing embodiment, the division of the second conductor 102 is capable to create multiple sub-feeding structures (three sub-feeding structures in FIGS. 5 and 6) in the antenna feeding structure. The multiple sub-feeding structures may be configured to implement feeding between multiple pieces of RF circuitry and the antenna, and/or may provide multiple feeding paths between one piece of RF circuitry and the antenna.

Reference is further made to FIG. 5. In one embodiment, the wireless device 100 includes three pieces of RF circuitry. As shown in FIG. 5, the wireless device further includes two pieces of RF circuitry, 402 and 403, besides the RF circuitry 401. Each piece of RF circuitry may refer to the RF circuitry of the foregoing embodiments, and the three pieces of RF circuitry may be identical, partially identical, or different from each other. For example, the RF circuitry 401 and the RF circuitry 402 may be configured to modulate or demodulate different copies of the same data or signal, or may be configured to modulate or demodulate data or signals of different channels. In this embodiment, the RF circuitry 401, the RF circuitry 402, and the RF circuitry 403 are all located on the circuit board 50. Similar to an embodiment as shown in FIG. 2, the RF circuitry 401 is electrically coupled to the second conductor 102, specifically the second sub-conductor 2011 via the coupling component 411. Moreover, the RF circuitry 401 is electrically coupled to the second conductor 102, specifically the second sub-conductor 2012 via the coupling component 412, and the RF circuitry 403 is electrically coupled to the second conductor 102, specifically the second sub-conductor 2013 via the coupling component 413. Thereby, there are three capacitor-like sub-feeding structure in the antenna feeding structure, and the antenna (not depicted in FIG. 5) is capable to transmit and receive oscillating currents to/from all the three pieces of RF circuitry via the three sub-feeding structures, respectively. It can be seen that a function of the antenna feeding structure is expanded. During wireless communication of the wireless device 100, the antenna may operate with the three pieces of antennas simultaneously, especially when the three pieces of the RF circuitry are configured to modulate and/or demodulate different copies of the same data or signals. Alternatively, the antenna may operate with one or two of the three pieces of RF circuitry each time, and the one or two pieces of RF circuitry may be selected from the three pieces of RF circuitry through another switching circuitry. For example, the switching circuitry may include a switch or a switching transistor connected between each pair of the RF circuitry and the second sub-conductor. It is appreciated that different pairs of the RF circuitry and the second sub-conductors may be identically configured as redundancy to improve system robustness, or may be differently configured to provide different functions, for example, to modulate or demodulate data or signals of different channels.

For clear illustration, the coupling components 411, 412, and 413 are depicted as lines running into the circuit board 50, and the three pieces of the RF circuitry, 401, 402, and 403, are depicted at a same side of the circuit board 50 as the antenna feeding structure. In practice, these coupling components may be implemented as wires disposed over the circuit board 50, or may be implemented through one or more wiring layers (or interconnection layers) of the circuit board 50. In the latter case, the coupling components may be disposed either in same layer(s) or in different layers. Moreover, at least one of the three pieces of the RF circuitry, 401, 402, and 403 may be disposed at an opposite side of the circuit board 50 with respect to the antenna feeding structure. Correspondingly, at least one of the three coupling components 411, 412, and 413 may run through the circuit board to achieve the coupling. The present application is not limited to any of the aforementioned cases.

Reference is further made to FIG. 6. In one embodiment, the antenna feeding structure further include second switching circuitry 105. The second switching circuitry 105 is configured to select one of the second sub-conductors 2011, 2012, or 2013 to connect the RF circuitry 401. The second switching circuitry 105 may have a single-pole three-throw structure as shown in FIG. 6. The single pole corresponds to a contact electrically connected to the coupling element 411, and the three throws correspond to three contacts electrically connected to the second sub-conductors 2011, 2012, and 2013, respectively. The RF circuitry 401 can be coupled to the second conductor 102, specifically to one of the three second sub-conductors 2011, 2012, or 2013, via the coupling component 411 and the second switching circuitry 105. Similar to an embodiment as shown in FIG. 5, there are three capacitor-like sub-feeding structure in the antenna feeding structure, and the antenna (not depicted in FIG. 5) is capable to transmit and receive oscillating currents to/from the RF circuitry 401 via a selected one of the three sub-feeding structures. The sub-feeding structures may be identically or substantially identically configured as parallel feeding paths between the RF circuitry 401 and the antenna, in order to provide redundancy and thereby improve robustness of the antenna feeding structure. Alternatively, the sub-feeding structures may be configured differently such that the RF circuitry when operate with different second sub-conductors is capable to perform different functions, for example, modulate or demodulate data or signals of different channels.

For clear illustration, the connections between the second switching circuitry 105 are depicted as lines running into the circuit board 50 and the second switching circuitry 105 are depicted as circuitry independent from the circuit board 50 in FIG. 6. In practice, these connections may be implemented as wires disposed above the circuit board 50, or may be implemented through one or more wiring layers (or interconnection layers) of the circuit board 50. In the latter case, the wires may be disposed either in same layer(s) or in different layers. Moreover, the second switching circuitry 105 may be located on either side of the circuit board 50. In a case that second switching circuitry 105 and the antenna feeding structure are located at different sides of the circuit board 50, the above connections may run through the circuit board 50. In a case that the second switching circuitry 105 and the RF circuitry 401 are located at different sides of the circuit board 50, the coupling component 411 may run through the circuit board 50. The present application is not limited thereto.

It is appreciated that the above cases of three second sub-conductors are merely examples illustrated in FIGS. 5 and 6. In practice, a quantity of the second sub-conductors may be, for example, two, four, five, or more. Those skilled in the art can deduce these cases by analogy on a basis of the embodiments as shown in FIGS. 5 and 6. Moreover, in some embodiments, technical solutions as shown in FIGS. 5 and 6 may be combined. That is, a first group of the multiple second sub-conductors may be configured to couple different pieces of RF circuitry as illustrated in FIG. 5, and a second group of the multiple second sub-conductors may be configured to couple the same RF circuitry via the second switching circuitry as shown in FIG. 4. In one embodiment, one or more second sub-conductors may belong to both the first group and the second group. In another embodiment, none of the second sub-conductors belongs to both the first group and the second group. The present application is not limited thereto.

In some embodiments, technical solutions as shown in FIGS. 3 to 6 may be further combined. That is, the antenna feeding structure may include the first conductor and the second conductor that are both divided into multiple sub-conductors. For example, one of the first sub-conductors may correspond to multiple second sub-conductors, such that an antenna may be fed by multiple pieces of RF circuitry, or fed by one piece of RF circuitry via multiple feeding paths. Additionally, one of the second sub-conductors may correspond to multiple first sub-conductors, such that a piece of RF circuitry may feed multiple antennas, or feed one antenna via multiple feeding paths. Therefore, the antenna feeding structure according to embodiments of the present application is capable to implement feeding between multiple antennas and multiple pieces of RF circuitry of a wireless device.

In one embodiment, at least a part of the isolating layer 103 is made of a dielectric material. As discussed above, the dielectric material may be a semiconductor, a polymer, oxide, nitride, ceramic, or rubber. The part of isolating layer 103 may refer to a part along a thickness direction. For example, the isolating layer 103 may include multiple layers, one of which is made of dielectric material. Alternatively, the part of the isolating layer 103 may refer to a part along a direction perpendicular to the thickness direction. For example, the isolating layer 103 may include multiple regions in contact with the first conductor 101 or the second conductor 102, and one of the multiple regions is made of the dielectric material. It is appreciated that the part of the isolating layer 103 may have an arbitrary shape, as long as it is located between the first conductor 101 and the second conductor 102. In one embodiment, the whole isolating layer 103 is made of the dielectric material.

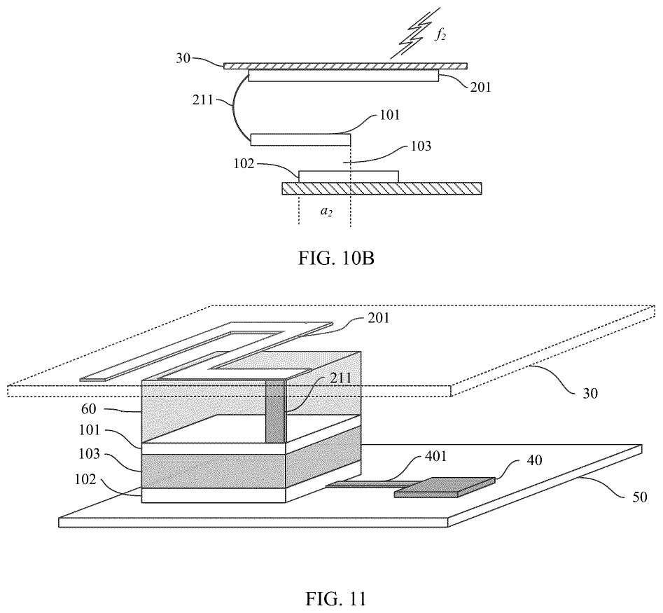

Reference is made to FIG. 7. In one embodiment, the isolating layer 103 is a part of the housing 30. In such case, the first conductor 101 may be exposed at an outer surface of the housing 30, as shown in FIG. 10, or may be embedded in the housing 30. Herein the term “outer” is a relative term which indicates a side opposite to a space enclosed by the housing 30, and may not necessarily indicate the first conductor 101 is exposed to an outside environment of the wireless device 100. For example, the first conductor 101 may be protected by a coating outside the layer, or there may be another housing out of the housing 30. In this embodiment, the part of the circuit board 50, at which the second conductor 102 is located, may be separated from the housing 30 by at least the second conductor 102. That is, the second conductor 102 is located between the housing 30 and the circuit board 50. The second conductor 102 may be in direct contact with the housing 30, as shown in FIG. 7, or there may be a material layer or a gap between the housing 30 and the second conductor 102. In one embodiment, the material layer may serve as a bonding layer between the second conductor 102 and the housing 30, and hence the antenna feeding structure is more stable.

In this embodiment, the part of the housing 30 is reused as a part of the antenna feeding structure, which improves spatial utilization efficiency of the antenna feeding structure and hence facilitate more compact architecture of the wireless device 100. Moreover, the first conductor 101 is closer to an outer side of the housing 10, such that the coupling component 211 may have a shorter length or even omitted when the antenna is attached to an outer surface of the housing, which reduces interference of/on other elements when the oscillating currents is transferred between the first conductor 101 and the part 201 of the antenna.

In FIG. 7, the isolating layer 103, i.e., the part of the housing 30, is depicted to have a same material as the surrounding portion of the housing 30. In practice, a heterogeneous structure may be used as an alternative based on an actual requirement. As an example, the housing 30 may be substantially elastic while the part is rigid to provide a stable feeding for the antenna feeding structure. As another example, the housing 30 may be substantially made of a conducting material such as metal while the part is made of a dielectric material.

In another embodiment, at least a part of the isolating layer 103 is made of air or a gas. The gas may be, for example, nitrogen or an inert gas to prevent internal components of the wireless device 100 from oxidization. Generally, the isolating layer 103 made of air or the gas is implemented as a gap separating the first conductor 101 and a second conductor 102. In some embodiments, a supporting structure is provided between the first conductor 101 and the second conductor 102 to ensure the separation. The supporting structure may occupy a small area, such as an edge or at least one corner of the space between the first conductor 101 and the second conductor 102. The supporting structure may be rigid or elastic based on an actual requirement.

In some embodiments, the first conductor 101 is fixedly connected to the housing 30 by, for example, the coupling component 211 or an additional bonding layer. The additional bonding layer may be disposed between the first conductor 101 and the housing 30, or between the first conductor 101 and the part 201 of the antenna. The fixed connection is configured to provide a support for the first conductor 101, especially when the isolating layer 103 includes the air or the gas. It is appreciated that the fixed connection may be either rigid or flexible.

As discussed above, the antenna feeding structure according to embodiments of the present application may behave like a capacitor. Hence, the antenna feeding structure may serve as a capacitor which is a component of circuitry between the RF circuitry and the antenna, and implement an additional function other than feeding. Reference is made to FIGS. 8a and 8b. In some embodiments, the antenna feeding structure serves as a capacitor in a matching circuit of the antenna. Generally, the matching circuit is configured to adjust an input impedance of the antenna to be close or equal to an impedance of the RF module (such as the RF circuitry 401). The antenna matching circuit may have a x-circuit structure, as shown in FIG. 8A, where the capacitor-like antenna feeding structure is indicated by the capacitor connected between the antenna side and the RF side. Alternatively, the antenna matching circuit may include only the capacitor connected between the antenna side and the RF side, as shown in FIG. 8B. It is appreciated that the antenna matching circuit may adopt other structures, as long as including a capacitor connected between the antenna side and the RF side, which can utilize the antenna feeding structure according to embodiments of the present application. In other embodiments, the antenna feeding structure may serve as a direct-current filter between the antenna and the RF circuitry. Reference may be further made to FIG. 8B, in which the direct-current filter is configured to remove or suppress the direct current in the oscillating currents transferred between the antenna and the RF circuitry. In practice, the antenna feeding structure serving as a direct-current filter usually has a larger capacitance than that serving in an antenna matching circuit. Therefore, the antenna feeding structure can be flexibly configured when designing inner circuitry of the wireless device. As an example, the antenna feeding structure may be configured to have a capacitance smaller than or equal to 10 pF when designed as a capacitor in the antenna matching circuit, and have a capacitance larger than 10 pF when designed as a direct-current filter. As another example, the antenna feeding structure may serve as a capacitor in the antenna matching circuit when having a capacitance smaller than or equal to 10 pF, and may serve as a direct-current filter when having a capacitance larger than 10 pF. It is appreciated that 10 pF in the above examples may be replaced by another value based on an actual requirement.

Alternatively, or additionally, the antenna feeding structure may serve as a capacitor in circuitry other than the antenna matching circuit and the direct-current filter, as long as the capacitor is connected between the antenna and the RF circuitry.

Hereinafter illustrated are some embodiments in which the antenna feeding structure may serve as a capacitor in the antenna matching circuit. As discussed above, the matching circuit is configured to adjust an input impedance of the antenna to be close or equal to the impedance of the RF circuitry. Since the impedance of the antenna is generally frequency-dependent, it may be necessary to tune the input impedance of the antenna when switching a frequency band in which the antenna operates, such that the antenna efficiency can be maintained as high as possible or the reflection coefficient of the antenna is maintained as low as possible. In such case, the capacitance of the antenna feeding structure may be adjusted to tune the impedance of the antenna.

Considering a classical parallel plate capacitor, which includes two conducting plates having an area of A separated by a uniform gap of thickness d filled with a dielectric with permittivity, an equation for calculating capacitance would be C=ε· A/d. Similarly, the capacitance of the antenna feeding structure may be adjusted through changing a distance between the first conductor 101 and the second conductor 102, changing an overlapping area between the first conductor 101 and the second conductor 102, or changing permittivity of the isolating layer 103 between the first conductor 101 and the second conductor 102.

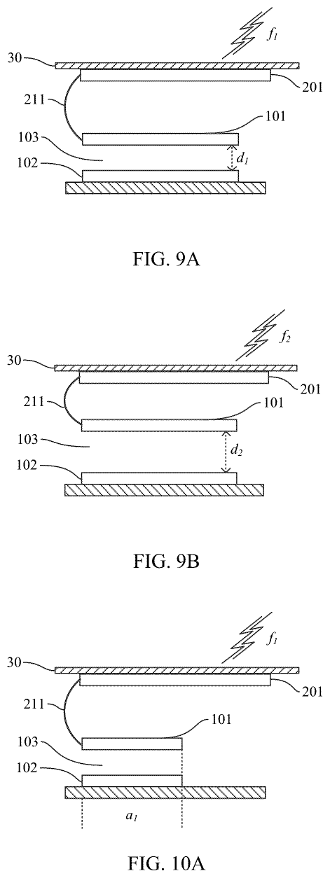

In one embodiment, the distance between the first conductor 101 and the second conductor 102 is changed. Reference is made to FIGS. 9a and 9b. The isolating layer 103 has a first thickness d₁ in a case that the antenna transmits receives wireless signals of a first frequency f₁, and has a second thickness de in a case that the antenna transmits or receives wireless signals of a second frequency f₂. The first thickness d₁ is different from the second thickness d₂, and the first frequency f₁ is different from the second frequency f₂. Herein the wireless signals “of a frequency” refers to that they are carried by electromagnetic waves of such frequency. The wireless signals of the first frequency f₁ and the wireless signals of the second frequency f may be transmitted under different communication standards, for example, under two standards among the WiFi-2.4 GHz, the WiFi-5 GHZ, the Bluetooth™, various 3GPP standards, or the like. As an example, when the wireless communication of the wireless device 100 is switched from a first standard using the first frequency f₁ to a second standard using the second frequency f₂, the capacitance C of the antenna feeding structure is required to decrease in order to maintain the antenna efficiency high or keep the reflection coefficient low. In such case, a distance between the first conductor 101 and the second conductor 102 (i.e., the thickness of the isolating layer 103) may be decreased from increased from d₁ to d₂. In practice, the thickness of the isolating layer 103 may be uniformly increased, as indicated in FIGS. 9a and 9b, and may alternatively be non-uniformly increased, for example, by raising only a side of the first conductor 101.

In another embodiment, an overlapping area between the first conductor 101 and the second conductor 102 is changed. Reference is made to FIG. 10A and FIG. 10B. Herein an overlapping region between the first conductor 101 and the second conductor 102 refers to an overlapping region when viewed along a thickness direction of the isolating layer 103, that is, the vertical direction in FIGS. 10a and 10b. The overlapping region has a first area a₁ in a case that the antenna transmits receives wireless signals of a first frequency f₁, and has a second area a₂ in a case that the antenna transmits or receives wireless signals of a second frequency f₂. Similar to the foregoing embodiment, the first area d₁ is different from the second area a₂, and the first frequency f₁ is different from the second frequency f₂, and the wireless signals of the first frequency f₁ and the wireless signals of the second frequency f₂ may be transmitted under different communication standard. As an example, when the wireless communication of the wireless device 100 is switched from a first standard using the first frequency f₁ to a second standard using the second frequency f₂, the capacitance of the antenna feeding structure is required to decrease in order to maintain the antenna efficiency high or keep the reflection coefficient low. In such case, an area of the overlapping region between the first conductor 101 and the second conductor 102 may be decreased from increased from a₁ to a₂. In practice, the change of the overlapping region may be implemented by relative movement between the first conductor 101 and the second conductor 102 within a plane perpendicular to the thickness direction, and the movement may be translational, rotational, or partially translational and partially rotational.

In some embodiments, the forgoing thickness or the forgoing overlapping area may be changed by using a dedicated physical mechanism connected to one or both of the first conductor 101 and the second conductor 102. Alternatively, the change may be induced by deformation of the component connected to one or both of the first conductor 101 and the second conductor 102, for example, by deformation of the housing 30 or the circuit board 50 which is flexible or elastic. As an example, the housing 30 may be squeezed, stretched, or twisted to induce the relative movement between the first conductor 101 and the second conductor 102, such that one or both of the forgoing thickness and the forgoing overlapping area is changed.

It is appreciated that the isolating layers 103 in FIGS. 8a to 9b are depicted as a gap only for clear illustration, and does not indicate that the foregoing embodiments is limited to cases in which the isolating layer 103 includes air or a gas. Rather, the foregoing embodiments can be implemented when at least a part of the isolating layer 103 is made of an elastic material.

In another embodiment, permittivity of the isolating layer 103 between the first conductor 101 and the second conductor 102 is changed. As an example, permittivity of the isolating layer 103 may change within a plane perpendicular to the thickness direction, and capacitance of the antenna feeding structure may be changed through relative movement between the isolating layer 103 and the two conductors 101 and 102 within such plane. As another example, permittivity of the isolating layer 103 may be anisotropic in a plane parallel with the thickness direction, and capacitance of the antenna feeding structure may be changed through by rotating the isolating layer 103 between the two conductors 101 and 102 within such plane. The present application is not limited thereto.

Hereinafter some embodiments are provided to illustrate performances of the foregoing capacitor-like antenna feeding structure. Reference is made to FIG. 11, which is a schematic three-dimensional (3D) structural diagram of an antenna feeding structure according to an embodiment of the present application. The antenna feeding structure as shown in FIG. 11 is substantially a 3D view of that as shown in FIG. 2, except that an additional layer 60 is indicated between the part 201 of the antenna and the first conductor 101, and the coupling component 211 runs through the additional layer. In this embodiment, the part 201 may be located at an inner surface of the housing 30, such that the additional layer 60 may be made of an insulating material, or may be air or a gas, so as to prevent direct electrical contact between the part 201 and the first conductor 101. It is appreciated that in a case that the part 201 is embedded in or disposed at an outer surface of the housing 30 that is made of an insulating material, the addition layer 60 may be made of other materials, such as a semiconductor. Moreover, the additional layer 60 may further provide support for the first electrode 101, for the whole antenna feeding structure, or even for the circuit board 50, by fixing the first electrode 101 to the housing 30. In such cases, the addition layer 60 may be made of a bonding material, such as an adhesive. Details of other components as shown in FIG. 11 may refer to the forging description, especially the part relevant to FIG. 2, and hence are not repeated herein.

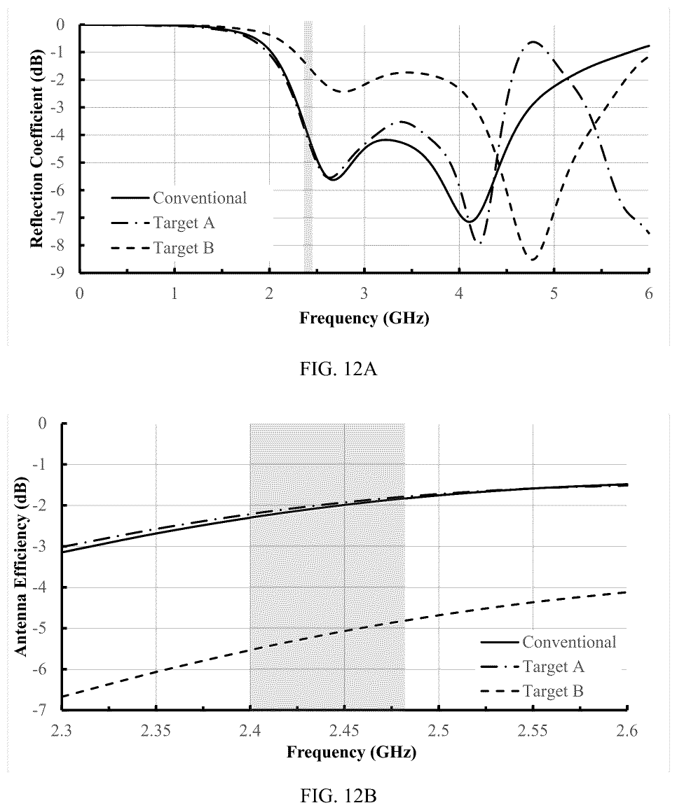

In one embodiment, as shown in FIG. 11, the part 201 is x-shaped and formed by metal stripes, the coupling component 211 is also a metal stripe, and the first conductor 101 and the second conductor 102 are both square metal pads. Specifically, the x-shaped part 201 is 10 mm high (in view of the character “x”) and 5 mm wide (in view of the character “x”), each metal stripe has a width of 1 mm, a thickness of the additional layer 60 is 2 mm, each squire metal pad has a dimension of 5 mm*5 mm*0.02 mm, and the isolating layer 103 is 0.05 mm thick with a uniform relative permittivity of 3. In such case, the capacitance of the antenna feeding structure is around 13.3 pF, which may serve as a direct-current filter. In comparison, a conventional feeding structure is also provided, and a difference between the antenna feeding structure according to this embodiment (hereinafter “target feeding structure”) and the conventional feeding structure only lies in that the two square pads, the isolating layer therebetween, and the coupling component 211 are replaced by a pogo-pin disposed vertically between the part 201 and the circuit board 50. FIGS. 12a and 12b illustrate graphs of reflection coefficients and antenna efficiencies of the target feeding structure (denoted as “Target A”) and the conventional feeding structure (denoted as “Conventional”) with respect to a frequency of the wireless signals. As shown in FIGS. 12a and 12b, in the frequency band ranging from 2.4 GHz to 2.48 GHz, which is indicated by the gray shade and which is a common frequency band for Wi-Fi and Bluetooth™, the target feeding structure and the conventional feeding structure have almost identical reflection coefficients and antenna efficiency. That is, the capacitor-like antenna feeding structure can improve robustness of the wireless device while ensuring the quality of wireless communication.

In another embodiment, the antenna feeding structure as shown in FIG. 11 are configured in same manner to the above embodiment, except that each squire metal pad has a reduced dimension of 2 mm*2 mm*0.02 mm, and the isolating layer 103 is 0.1 mm thick with a uniform relative permittivity of 10. In such case, the capacitance of the antenna feeding structure is around 3.5 pF, which may serve as a capacitor of an antenna matching circuit. Similarly, the foregoing conventional feeding structure using a pogo-pin serves as a comparison. FIGS. 12a and 12b further illustrate graphs of reflection coefficients and antenna efficiency of such target feeding structure (denoted as “Target B”) with respect to a frequency of the wireless signals. As shown in FIGS. 12a and 12b, in the frequency band ranging from 2.4 GHz to 2.48 GHZ, the reflection coefficient of this target feeding structure is approximately 2.3 dB higher than the conventional feeding structure, and antenna efficiency of this target feeding structure is approximately 3.2 dB lower than the conventional feeding structure. The capacitor-like antenna feeding structure provide compatible performances in comparison with the conventional feeding structure. It is noted that the slight degrade in the reflection coefficient and the antenna efficiency is mainly due to the high permittivity introducing a large dielectric loss tangent. Reducing the permittivity and increasing the area of the two conductors can suppress the degradation significantly without changing the capacitance of the antenna feeding structure. It is further noted that an increased area of the two conductors may further improve physical stability of the antenna feeding structure, especially when the isolating layer is made of the dielectric material.

On a basis of the foregoing embodiments, an electronic device is further provided according to an embodiment of the present application. The electronic device may be the wireless device as shown in FIG. 2. That is, the electronic device includes a housing 30, an antenna located at the housing 30, a circuit board 50, and the antenna feeding structure according to any of the foregoing embodiments.

In an embodiment, no component physically connecting the antenna and the circuit board is under compressive stress. That is, the electronic device having the capacitor-like antenna feeding structure is capable to be stress-free after assemblage, and therefore is more robust to large impact and large deformation.

In an embodiment, the electronic device further includes an insulating layer located between the first conductor 101 and the part 201 of the antenna, and the first conductor is electrically coupled to the part 201 of the antenna via a conductor running through the insulating layer. The insulating layer may be configured to fix the first conductor 101 to the housing 30. In practice, the conductor may be implemented by a wire, a cable, or a conducting stripe as shown in FIG. 11.

The embodiments of the present application are described in a progressive manner, and each embodiment places emphasis on the difference from other embodiments. Therefore, one embodiment can refer to other embodiments for the same or similar parts. Since the electronic device disclosed in the embodiments corresponds to the antenna feeding structure disclosed in the embodiments, the description of the electronic device is simple, and reference may be made to the relevant part of the antenna feeding structure.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more”. Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

It should be noted that, the relationship terms such as “first”, “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including a . . . ” does not exclude the case that other similar elements may exist in the process, the method, the article or the device other than enumerated elements.

According to the description of the disclosed embodiments, those skilled in the art can implement or use the present application. Various modifications made to these embodiments may be obvious to those skilled in the art, and the general principle defined herein may be implemented in other embodiments without departing from the spirit or scope of the present application. Therefore, the present application is not limited to the embodiments described herein but confirms to a widest scope in accordance with principles and novel features disclosed in the present application.

What is claimed is:

1. An antenna feeding structure, comprising:
a first conductor, electrically coupled to a part of an antenna, wherein the part of the antenna is located at a housing of an electronic device;
a second conductor, electrically coupled to radio-frequency (RF) circuitry on a circuit board, wherein the second conductor is located on a part of the circuit board, and the part of the circuit board is enclosed in the housing; and
an isolating layer, located between the first conductor and the second conductor, wherein the first conductor is isolated from the second conductor via the isolating layer.

2. The antenna feeding structure according to claim 1, wherein:
each of the first conductor and the second conductor is a sheet,
the first conductor is conformed to at least a part of the second conductor, or the second conductor is conformed to at least a part of the first conductor.

3. The antenna feeding structure according to claim 2, wherein the first conductor comprises a plurality of first sub-conductors which are separated from each other.

4. The antenna feeding structure according to claim 3, wherein:
a first sub-conductor of the plurality of first sub-conductors is electrically coupled to the part of the antenna;
another first sub-conductor of the plurality of first sub-conductors is electrically coupled to a part of another antenna; and
the part of the another antenna is located at the housing.

5. The antenna feeding structure according to claim 3, further comprising:
first switching circuitry, configured to select one of the plurality of the first sub-conductors to connect the part of the antenna.

6. The antenna feeding structure according to claim 2, wherein the second conductor comprises a plurality of second sub-conductors which are separated from each other.

7. The antenna feeding structure according to claim 6, wherein:
a second sub-conductor of the plurality of second sub-conductors is electrically coupled to the RF circuitry; and
another second sub-conductor of the plurality of second sub-conductors is electrically coupled to another RF circuitry on the circuit board.

8. The antenna feeding structure according to claim 6, further comprising:
second switching circuitry, configured to select one of the plurality of the second sub-conductors to connect the RF circuitry.

9. The antenna feeding structure according to claim 1, wherein at least a part of the isolating layer is made of a dielectric material.

10. The antenna feeding structure according to claim 9, wherein:
the first conductor is exposed at an outer surface of the housing or embedded in the housing; and
the isolating layer is a part of the housing, and the part of the circuit board is separated from the housing by at least the second conductor.

11. The antenna feeding structure according to claim 1, wherein at least a part of the isolating layer is made of air or a gas.

12. The antenna feeding structure according to claim 1, wherein the antenna feeding structure serves as a capacitor in a matching circuit of the antenna.

13. The antenna feeding structure according to claim 12, wherein:
the isolating layer has a first thickness in a case that the antenna transmits or receives wireless signals of a first frequency;
the isolating layer has a second thickness in a case that the antenna transmits or receives wireless signals of a second frequency; and
the first thickness is not equal to the second thickness, and the first frequency is different from the second frequency.

14. The antenna feeding structure according to claim 12, wherein:
an overlapping region between the first conductor and the second conductor, along a thickness direction of the isolating layer, has a first area in a case that the antenna transmits or receives wireless signals of a first frequency;
the overlapping region has a second area in a case that the antenna transmits or receives wireless signals of a second frequency;
wherein the first area is not equal to the second area, and the first frequency is different from the second frequency.

15. The antenna feeding structure according to claim 1, wherein the antenna feeding structure serves as a direct-current filter between the antenna and the RF circuitry.

16. The antenna feeding structure according to claim 1, wherein the first conductor is fixedly connected to the housing.

17. An electronic device, comprising:
a housing,
an antenna located at the housing,
a circuit board, and
the antenna feeding structure according to claim 1.

18. The electronic device according to claim 17, wherein no component physically connecting the antenna and the circuit board is under compressive stress.

19. The antenna feeding structure according to claim 17, wherein the part of the antenna is a conducting pattern disposed at a surface of the housing.

20. The electronic device according to claim 18, further comprising an insulating layer located between the first conductor and the part of antenna, wherein the first conductor is electrically coupled to the part of the antenna via a conductor running through the insulating layer.
